(19) United States
(12) Patent Application Publication
(10) Pub. No.: US 2014/0310064 A1
(43) Pub. Date: Oct. 16, 2014

(54) PRICING PERSONALIZED PACKAGES WITH MULTIPLE COMMODITIES

(71) Applicant: INTERNATIONAL BUSINESS MACHINES CORPORATION, Armonk, NY (US)

(72) Inventors: Pawan R. Chowdhary, Montrose, NY (US); Markus R. Ettl, Ossining, NY (US); Shivaram Subramanian, Danbury, CT (US); Zizhuo Wang, Minneapolis, MN (US); Zhengliang Xue, Yorktown Heights, NY (US)

(73) Assignee: International Business Machines Corporation, Armonk, NY (US)

(21) Appl. No.: 13/863,812

(22) Filed: Apr. 16, 2013

(51) Int. Cl. G06Q 30/02

(52) U.S. Cl. CPC G06Q 30/0283
USPC 705/7.35

(57) ABSTRACT

A top-down and bottom-up approach that decomposes product bundles to components, classifies them into different groups corresponding to a component similarity measure, and detects their inherent values. The bundles are reassembled and characterized by several key attributes according to their component inherent values, and classified into segments. A normalized utility model is constructed for each product bundle segment, taking into account the additive effect among different commodity types and product families. The goodness of fit of the top-down and the bottom-up model may be validated. The model may be applied in an RFQ pricing environment.

### FIELD

The present application relates generally to supply chain sustainability management and computerized applications thereof, and more particularly to pricing personalized packages with multiple commodities.

### BACKGROUND

A typical product configuration (also referred to as a package or a bundle) consists of multiple commodities such as hardware, software and service. In a sale-purchase scenario, a buyer may submit a request for quote (RFQ) for a desired quantity of each component in the bid configuration, and propose a requested bundle price to a seller. The seller then may review the bid configuration and offer an approved bundle price to the buyer. The buyer may subsequently decide whether to purchase the entire bundle at the approved price. However, a product bundle can include a large number of different components, in which the seller often lacks the knowledge of the distribution of component reservation prices and correlations among components.

Bundle pricing in an environment of personalized, complex and unique bids with multiple commodities presents challenges not found in single commodity purchasing environments. For instance, industry data from a large high-technology manufacturer shows that 90% of personalized bundles were uniquely configured, and 30% of components were rarely selected by clients. Therefore, correlations among components are difficult to calibrate, and the willingness of a buyer to buy a bundle is not easy to measure. Such properties of personalized bundles make the seller's pricing decision exceptionally challenging.

### BRIEF SUMMARY

A method of pricing a package with multiple commodities, in one aspect, may comprise decomposing the package into the multiple commodities. The method may also comprise computing a value score for each of the multiple commodities based on at least one or more characteristics associated with said each of the multiple commodities. The method may further comprise computing a value score for the package based on at least the value score of each of the multiple commodities. The method may also comprise determining a package type of the package based on at least the value score of each of the multiple commodities. The method may also comprise identifying a segment for the package based at least on the package type and the value score of the package, from a plurality of segments each associated with a utility function. The method may also comprise computing the utility function associated with the identified segment to determine a package price.

A system for pricing a package with multiple commodities, in one aspect, may comprise a pricing module operable to execute on the processor and further operable to decompose the package into the multiple commodities. The pricing module may be further operable to compute a value score for each of the multiple commodities based on at least one or more characteristics associated with said each of the multiple commodities. The pricing module may be further operable to compute a value score for the package based on at least the value score of each of the multiple commodities. The pricing module may be further operable to determine a package type of the package based on at least the value score of each of the multiple commodities. The pricing module may be further operable to identify a segment for the package based at least on the package type and the value score of the package, from a plurality of segments. Each segment may be associated with a corresponding utility function. The pricing module may be further operable to compute the utility function associated with the identified segment to determine a package price.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a sample of personalized packages.

FIG. 2 illustrates an example of a hierarchical segmentation of personalized packages.

FIG. 3 shows model validation based on business impact in one embodiment of the present disclosure.

FIG. 4 illustrates a method for pricing personalized product bundles with unique configurations in one embodiment of the present disclosure.

FIG. 5 illustrates a method of using historical data to generate utility functions associated with package bundles in one embodiment of the present disclosure.

FIG. 6 shows a bundle utility function defined for personalized packages.

FIG. 7 shows a normalized utility function in one embodiment of the present disclosure.

FIG. 8 shows a win probability estimation and price optimization formula in one embodiment of the present disclosure.

FIG. 9 illustrates a schematic of an example computer or processing system that may implement a pricing system in one embodiment of the present disclosure.

### DETAILED DESCRIPTION

In one embodiment of the present disclosure, a pricing strategy of request-for-quotes (RFQs) may be provided for a package (e.g., a personalized package) having multi-commodity product (and/or service) configuration, for example, unique or distinctive (nearly unique or distinctive) configuration. A package in the present disclosure is also referred to as a bundle.

For example, a buyer may customize the package, and submit an RFQ to a seller, asking for a desired quantity for each component and proposing a requested price for the entire bundle. The seller reviews the package and offers a bundle price to the buyer. The buyer then decides whether to purchase the entire package at that seller's approved price. In this respect, the seller is offering the entire bundle; For example, the seller does not allow the buyer to purchase part of the bundle.

A methodology of the present disclosure in one embodiment for pricing strategy may be utilized by a provider of information and service, e.g., that may offer a high number (e.g., thousands) of components to build up, e.g., a large-scale information technology (IT) system. Such a provider may allow a client to customize or personalize a package which typically includes hundreds of components. The components may include hardware, software and service.

In the present disclosure, it is observed that some of the components may not be selected (or only rarely selected) by any customers, and therefore difficult to estimate the customer's willingness to buy. Also, since the packages include a combination of multiple components, more difficulty exists in being able to directly estimate the demand elasticity for an individual component. It is also observed that a high percentage of personalized packages were never seen before. Therefore, the correlation among components is hard to calibrate. Such factors associated with the personalized packages create complicity and challenge in seller's pricing decision.

The pricing strategy in one embodiment of the present disclosure analyzes the personalized packages that, for example, do not have previous or historical sales data (or lack sufficient data), for example, because those personalized packages did not appear in the sales history. In one aspect, a utility-based model may be generated to estimate the purchase probability of each product bundle. The utility-based model may be used to obtain a pricing decision that would be optimal for a personalized bundle with distinctive configuration.

In the present disclosure in one embodiment, a personalized bundle may be characterized by some key attributes. To obtain or calibrate these attributes from real data, a top-down and bottom-up approach is presented. The top-down and bottom-up approach may determine the similarity at both the component and bundle level, which enables a seller to detect common characteristics of various bundles and group them to analyze the price elasticity. In one embodiment, the top-down model fully decomposes all the bundles to components, groups the components based on the similarity of component features, and evaluates their inherent value (e.g., market value) based on the component features. Then, the bottom-up model aggregates the component value to the bundle level, building up metrics to merge similar bundles. The bottom-up model reassembles components to a bundle and characterizes it by key attributes. For example, in a bundle that includes computer components such as a server system and hardware, the key attributes that characterize the bundle may include a weight associated with the server system, a weight associated with hardware commodity, leading family, etc. These attributes are used to segment the bundles, i.e., group various bundles into several segments based on the attributes. In each segment, a normalized utility is calibrated by recursively considering the correlation among different commodities and product families. After grouping the similar packages, a choice model based on the utility function may be set up and applied to estimate or calculate the purchase probability, and optimize the bundle price. The bundle price may be optimized by balancing the profit margin and purchase probability. A new criterion to measure the profit increment may be suggested to verify the business impact.

In one embodiment of the present disclosure, the top-down model uses all the historical data at the component level, for example, the component list price, delegation price, total manufacturing cost (TMC), and product family. The bottom-up model generates the metrics at the bundle level by aggregating the component data. All the information at the bundle level, such as client type, channel type and weight of hardware may be also applied in the bottom-up model.

A bundle (package) is defined as a combination of components. Bundles may be classified into two types: seller-determined bundle and buyer-designed bundle (e.g., personalized bundle by a buyer). The methodology of the present disclosure may apply to pricing of both types of bundles. Thus, for example, the methodology of the present disclosure in one embodiment may be utilized in pricing of both seller-determined bundles and buyer-designed bundle, where there is limited price history due to the large number of combinations of components in the bundles.

In one embodiment of the present disclosure, examples of component features or characteristics the top-down model uses to calculate the component market value may include, but are not limited to: Commodity type such as software, hardware, service; Product family such as a group of components with the similar functionality; Shelf-life information, e.g., whether newly released, mature, upgrades; Market position such as no competition, few competition, full competition; Cost parameter such as cost, delegation price and list price for each component (The list price shows the market value; the delegation price may be “cost plus” price that is equal to the cost plus a desired margin by the seller). The top-down model may calculate the component market value based on those features for historical RFQs, e.g., sales data of previously sold bundles.

For historical RFQs, a methodology in one embodiment of the present disclosure may decompose the approved bundle price to each component by using the list price as the weight. The approved price here refers to the seller's price of the entire bundle. The approved price is decomposed to price for each component. Such decomposed approved prices (at the component level) can be regarded as a proxy of the component market value. The methodology may further assume that the market value is determined by all or a plurality of selected example features. A general linear regression model may be employed to determine the relationship between market value and features. In one aspect, the relationship might be completely different across commodities and product families. Therefore, the methodology in one embodiment also may apply a classification model on top of the regression model. For example, the components may belong to a variety of product families, e.g., High-End Power Server, Median Power Server, Low-End Power Server, High-End Storage (DS 8K), Low-End Storage (DS 4K), Storage area network (SAN), Tape, etc. Also, the tape might be further classified in terms of its quality level. Thus, the classification model may identify the “similar” components and group them together for the regression. As a result, the inherent value (market value) of each component based on these features may be estimated.

The bottom-up model uses the inherent value of each component to build up the bundle utility. For instance, after determining the inherent value (market value) of every component in the bundle, the bottom-up method in the present disclosure in one embodiment aggregates them to estimate the market value of the bundle consisting of those components. In one aspect, the aggregation considers the correlation between the components, as well as taking into account the sum of all the component values. Thus, the market value of the bundle is estimated as a function of its component values. For example, as will be explained in more detail below, an example of the bundle utility is formulated in Equation (1) below, as the aggregated market value of the bundle minus the bundle price plus a random factor. Thus, the methodology of the present disclosure in one embodiment estimates the market value of the bundle as a function of the market values of its components. The methodology may use the component value calculated in the top-down model to determine the metrics to characterize all the bundles, for example, by the following attributes: Weight of each commodity such as software, hardware, service; Weight of each family such as server system, storage system; Channel type such as direct channel, indirect channel; Bundle size; Demographic information of client such as transaction history, and others. An example of a bundle attribute or characteristic may be that is hardware-based. Another example of a bundle attribute is that it has certain server as leading family. In order to determine or identify a bundle characteristic or attribute (e.g., whether the bundle is hardware-based, has HE Power Server as leading family), metrics are set up to mathematically measure attributes. For example, if the total value of hardware components is known to be equal to $86K, and total value of the bundle is equal to $100K, then the weight of hardware=86%, which is well above 50%. In that case, the bundle is identified as hardware-based, e.g., even though there may be 14% software and services included in the bundle. Similarly, if the total value of all the HE Power Server components counts for 57%, then the leading family may be identified as HE Power Server.

Based on those weights (measured attribute values or metrics, e.g. server-based or storage-based, weight of the commodity (hardware-based or software-based), and weight of the product family), the methodology of the present disclosure may define a leading commodity which has the highest weight in the bundle. Similarly, the methodology may characterize a leading family for each bundle. A leading family is the product family in the bundle that has the highest weight. Using these attributes (a set of characteristics to describe the bundle property, e.g., commodity composition, leading family, quality grade of the package, etc.), the methodology in one embodiment of the present disclosure may define the bundle similarity based on these attributes and assign similar bundles to the same segment.

To introduce the weight of commodities and families into the regression model, the methodology of the present disclosure may normalize the utility (e.g., Equation (1) below) by the aggregated value of the bundle, and recursively calculate the component dependency between different commodities and families (e.g., Equations (4), (5), (6) below). As a result, a utility function for each bundle may be obtained. A logit model and probit model may be generated based on the utility function to estimate the purchase probability of each package. Such models allow for learning the demand elasticities (or purchase probabilities) that are part of the pricing optimization.

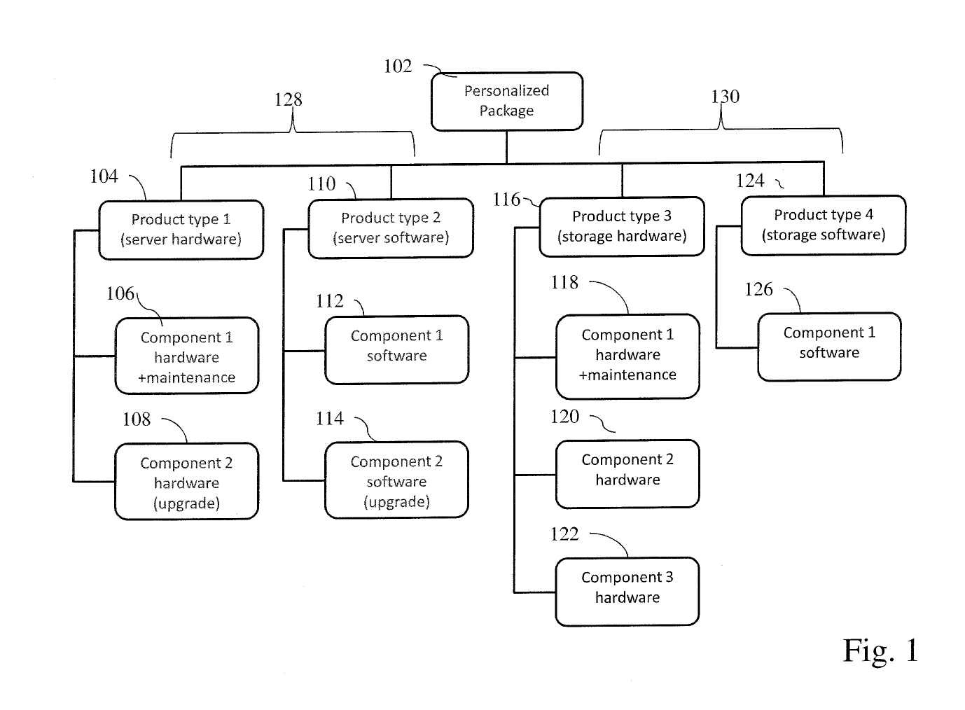

The following example scenario describes the above-described methodology in detail in one embodiment of the present disclosure. Consider a buyer submitting an RFQ for a personalized package to a seller, for example, who provides information systems and services based on a set of components. The set of components may be used to build server and storage systems. FIG. 1 illustrates a sample of a personalized package. A package 102 is composed of multiple commodities, for example, hardware, maintenance and software. In this example, a package includes product type 1 (server hardware) 104 and associated components, e.g., component 1 (hardware and maintenance, e.g., maintenance is attached to a corresponding hardware) 106, component 2 (hardware upgrade) 108; product type 2 (server software) 110 and associated components, e.g., component 1 (software) 112, component 2 (software upgrade) 114; product type 3 (storage hardware) 116 and associated components, e.g., component 1 (hardware and maintenance) 118, component 2 (hardware) 120, component 3 (hardware) 122; and product type 4 (storage software) 124 and associated components, e.g., component 1 (software) 126. A component may belong to a server system 128 or a storage system 130. The former 128 offers a large-scale computational capability to provide commercial and scientific solutions, while the latter 130 installs and processes the data as a data-hub.

Consider a seller offering thousand components to build a variety of server and storage systems. A component is indexed by jεJ={1, . . . , J}. The complete set of server components is denoted by SRV. The complete set of storage components is denoted by STG. All the components can be classified into two commodity types: hardware and software, denoted by H and S respectively. A personalized bundle is denoted by B. A component j is in the bundle, if jεB. The following parameters may be defined for each bundle:
a. • p_{B}, bundle price as the decision variable;
b. •

$${\overline{p}}_{B} = {\sum }_{j ∈ B} {\overline{p}}_{j} ,$$

bundle list price as an upper bound of p_{B}, with p̅_{B}= p̅_{H}+ p̅_{S};
c. •

$${c}_{B} = {\sum }_{j ∈ B} {c}_{j} ,$$

bundle cost as a lower bound of p_{B}, with

$${c}_{B} = {\sum }_{j ∈ B} {c}_{j} = 0 ;$$

d. • v_{B}, bundle value as a function of v_{H} and v_{S}, with

$${v}_{H} = {\sum }_{j ∈ H} {v}_{j} and {v}_{S} = {\sum }_{j ∈ S} {v}_{j} .$$

Here vⱼ is the inherent value of each component j, and v_{S} is the inherent value of the package. The general effect of component correlation is superadditive, if

$${v}_{B} > {\sum }_{j ∈ B} {v}_{j} .$$

It is subadditive, if

$${v}_{B} < {\sum }_{j ∈ B} {v}_{j} .$$

The component valuation (vⱼ) and the bundle valuation are described further below.

Any bundle belongs to a certain segment indexed by iε|={1, . . . , I}. For example, consider the segmentation based on the commodity type, if the weight of hardware is high than 80%, the bundle is considered to be hardware-based, if the weight is less than 30%, the bundle is considered to be software-based, if it is between 30% and 80%, the bundle is considered to be a mixed bundle. A segment is a group of bundles having “similar” attributes. These attributes may be fully characterized by some parameters such as p̅_{B}, c_{B}, v_{B}, v_{H}, v_{S}, and etc. Those attributes are specified below.

Then the utility of the package is formulated as below:

U_{B}ⁱ=α+α_{c}c_{B}+αₗ p̅_{B}−βp_{B}+γ_{H}v_{H}+γ_{S}v_{S}+ε_{B}ⁱ (1)

The utility function leads to a regression model. All the regression coefficients (αs, βs and γs) are specified by the corresponding segment and attributes.

A top-down and bottom-up method to calculate all the unknown regression variables such as v_{H}, v_{S} and others are described herein. The cost C_{B}, list price p̅_{B}, and bundle approved price p_{B} can be directly obtained from the historical data. The value of all the hardware components, the value of all the software component are not available in the historical data. In the present disclosure in one embodiment, the value is estimated and calculated based on the component features, for example, which may be directly found in a database storing information about the components.

### Top-Down Model

Top-down model includes the component valuation for vⱼ. The main features of each component, which determine its inherent value are elaborated. How the sellers and buyers evaluate each component from their own perspectives are addressed. A conjoint analysis (component valuation) that links the inherent value to the features is performed.

### Component Features

An inherent value is characterized by the features of each component. To understand the functionality of a component, the following aspects may be considered: commodity type (e.g., software/hardware/service); product family (group of components with the similar functionality); shelf-life information (new released, matured, upgraded items); market position (degree of competition); cost parameter (cost, delegation price and list price).

The inherent value may be estimated based on those or other features. In this example, the cost (cⱼ) may include the manufacturing cost. In one aspect, this manufacturing cost for software may be considered zero. The delegation price usually reflects the seller's tolerance to the minimum profit margin. For instance, if the seller cannot tolerate a profit margin less than 20% for a hardware component j, then the delegation price is \hat{p}ⱼ=(1+20%)cⱼ. The list price ( p̅ⱼ) shows the seller's expectation on the maximum market value. In this example, the inherent value may be expected to be a function of these cost parameters, that is vⱼ=fⱼ(cⱼ, \hat{p}ⱼ, p̅ⱼ) where cⱼ≦\hat{p}ⱼ≦ p̅ⱼ. The cost parameters of software are different from those of hardware. For example, the software cost is zero, and the delegation price is regarded as the maximum discount from the list price, which is tolerated by the seller. In summary,

vⱼ=fⱼ(cⱼ,\hat{p}ⱼ, p̅ⱼ), with \hat{p}ⱼ=cⱼ+θ( p̅ⱼ−cⱼ), for jεH;

vⱼ=fⱼ(0,\hat{p}ⱼ, p̅ⱼ), with \hat{p}ⱼ=θ p̅ⱼ, for jεS.

The list price may be available as public information, whereas the cost and delegation price may be considered seller proprietary information.

### Inherent Value of Component

To measure the inherent value of a component, the component may be observed from the perspective of the seller. It is learned that the approved price (p_{B}) shows the seller's valuation on the entire bundle. Approved price is the bundle price decided by the seller. Reservation price is the maximum price at which a buyer is willing to buy. Even though the component value is not known exactly, it can be approximated by breaking down the bundle price to each component. The methodology of the present disclosure uses historical data to figure out what is the function of the market value (e.g., v=f( )). Then the optimal price for a new bundle may be determined by solving, for example, Equation (8) below. Using the delegation price as the weight, vⱼ^{s}=ŵⱼp_{B}, with ŵⱼ=\hat{p}ⱼ/\hat{p}_{B} is derived. Note ŵⱼ is the seller's hidden information. Here, the superscript “b” denotes the buyer and the superscript “s” denotes the seller.

The component may be also evaluated from the perspective of the buyer. Sometimes buyers are willing to provide their requested price (\tilde{p}ⱼ) on each component j. If so, the methodology directly learns vⱼ^{b}=\tilde{p}ⱼ. Otherwise, the methodology breaks down the bundle requested price (\tilde{p}_{B}) to each component. Using the list price as the weight, vⱼ^{b}= w̅ⱼ\tilde{p}_{B}, with w̅ⱼ= p̅ⱼ/ p̅ⱼ is derived. Note w̅ⱼ is the open information observed by all buyers.

One embodiment of the methodology considers that the actual inherent value vⱼ is tightly correlated to vⱼ^{b} and vⱼ^{s}. Here, vⱼ^{b} is completely based on the outside information, whereas vⱼ^{s} is determined by the inside information of the seller. In one embodiment of the present disclosure, the inherent value may be calculated as a linear combination of the requested price and approved price, that is vⱼ=λⱼvⱼ^{b}+(1−λⱼ)vⱼ^{s}. The weight depends on the data availability. For example, consider a newly released component. More weight may be given on the seller's valuation, since the seller may have more knowledge on its functionality and performance. As another example, more weight may be given on the buyer's valuation, if the component is a popular one used by many customers.

Even though the inherent value of each component is calculated, one cannot directly obtain the distribution of its reservation price because for example, there is not enough data for those new released and rarely used components and because the purchase decision depends on the reservation price of the entire bundle rather than a single component. Therefore, it is very difficult to directly estimate a component reservation price, if that component is always combined with the others. Hence, in the component analytics in one embodiment of the present disclosure, its inherent value is estimated instead of the distribution of reservation price. Next, the features are linked to the inherent value.

### Classification and Regression Model of Component Valuation

The conjoint analysis is performed based on the classification and regression models. First, these components are classified to serval groups based on the commodity type and product family. For example, consider IBM (International Business Machines Corporation, Armonk N.Y.) grouping of the storage components into serval families: DS-4000: DS-8000, Storage-Area-Network (SAN), ProtecTIER, Storwize, and etc. Also, the server hardware and software can be classified in a similar way. Therefore, all the components can be classified into K groups such as J₁, . . . , and J_{K}, where J=J₁∪ . . . ∪J_{K}.

For any component in the same group indexed by k, the methodology expects to have a similar connection from the features to the inherent value. It is formulated by vⱼ=fₖ(cⱼ, \hat{p}ⱼ, p̅ⱼ), for any jεJₖ, k=1, . . . , K. Here, k is the index of the component class. A component classification model may determine classes for all components. For example, a linear model is specified as

vⱼ=ρ₀ₖ+ρ₁ₖcⱼ+ρ₂ₖ\hat{p}ⱼ+ρ₃ₖ p̅ⱼ+ρ₄ₖtⱼ+ρ₅ₖ1ⱼ+εⱼ. (2)

Here, tⱼ is the age of component j. Given its releasing day and withdrawal day, the entire shelf-life of a component is measured by the days from its release to withdrawal. The current age is equal to the days after release divided by the entire shelf-life. Let 1ⱼ be an indication function showing the market position of family j. It is equal to 1, if the seller is a leading provider for that product family. The random variable εⱼ describes the unknown factors in the component valuation. All the rhos are the unknown coefficients, to be solved by the regression model.

As another example, another log-linear model may be considered, that may be specified as

log(vⱼ)=ρ₀ₖ+ρ₁ₖ log(cⱼ)+ρ₂ₖ log(\hat{p}ⱼ)+ρ₃ₖ log( p̅ⱼ)+ρ₄ₖtⱼ+ρ₅ₖ1ⱼ+εⱼ. (3)

The goodness of fit for the regression models is justified by the R². For example, R²>0.85 may indicate that the valuation is reliable.

### Bottom-Up Model

The bottom-up model uses the inherent value to build up the bundle utility as in (1). First, the methodology of the present disclosure may use vⱼ to determine the metrics to characterize all the packages, and determine their similarity. Then the methodology may normalize the utility by the aggregated value of the bundle, putting together the “similar” bundles even with different sizes. A choice model such as logit model and probit model may be generated to estimate the purchase probability of each package.

### Characteristic of Package

Given a set of components J, any bundle can be fully characterized by a J-dimension vector, v={vⱼ}_{jεJ}. Denote vⱼ=0, if component j is not in the bundle B. Given thousands of components, it may be infeasible to directly apply any existing clustering algorithm to identify and group the “similar” packages corresponding to this vector. Therefore, metrics may be built up to characterize the attributes of each package. Such attributes may be calibrated on the basis of the inherent value. The attributes may include:

• w_{c}={w_{H}, w_{S}}, with the weight

$${w}_{H} = \frac{{\sum }_{j ∈ H ⋂ B} {v}_{j}}{{\sum }_{j ∈ B} {v}_{j}} ,$$

for a commodity type H;
• w_{f}={w₁, . . . , w_{K}}, with the weight

$${w}_{k} = \frac{{\sum }_{j ∈ {J}_{k} ⋂ B} {v}_{j}}{{\sum }_{j ∈ B} {v}_{j}} ,$$

for a product family k=1, . . . , K;
•

$${k}^{*} = arg {max}_{k = 1 , … , K} {w}_{k} ,$$

which is the leading family that provides the highest value in the package;
•

$${r}_{c} = \{ \frac{{c}_{B}}{{\sum }_{j ∈ B} {v}_{j}} , \frac{{\overline{p}}_{B}}{{\sum }_{j ∈ B} {v}_{j}} \} ,$$

which indicates the overall quality grade of the package.

The configuration of a bundle may be characterized by w_{f}, which shows the contribution of each product family to the entire bundle. K here refers to the number of possible product families in a bundle. A product family k* is called a leading family of the bundle, if w_{k*}≧wₖ, for any k≠k*. The number of families of concern depends on the data availability. The simplest case (K=2) decomposes the bundle into a server system and a storage system. A storage system could be further broken down to DS-Low-End (DS-4000: DS-6000), DS-High-End (DS-8000), Storage-Area-Network (SAN), ProtecTIER, Tape, and etc. Also a server system could be decomposed to Power-High-End, Power-Median and Power-Low-End.

A bundle is hardware-base, if w_{H} approaches 1. It is software-base, if w_{H} approaches 0. Such bundle could be a software upgrade of the operating system and storage management. It is a mix-base, if w_{H} is around 0.5. If the bundle is hardware-base, its overall grade is indicated by

$$\frac{{c}_{B}}{{\sum }_{j ∈ B} {v}_{j}} .$$

It is smaller if the bundle contains more high-end hardware. It may be observed that any high-end hardware would provide a higher profit margin,

$$\frac{{\sum }_{j ∈ B} {v}_{j} - {c}_{B}}{{c}_{B}} .$$

With regard to software-base bundles, c_{B}=0. Instead, its overall grade is measured by

$$\frac{{\overline{p}}_{B}}{{\sum }_{j ∈ B} {v}_{j}} .$$

It is higher when the bundle contains more high-end software. It may be observed that any high-end software has less discount from the list price, measured by

$$\frac{{\overline{p}}_{B} - {\sum }_{j ∈ B} {v}_{j}}{{\overline{p}}_{B}} .$$

Compared to a J-dimension vector, a simple way to characterize each bundle is focused on its attributes which correspond to the metrics described above, e.g., weight of each commodity, weight of each family, leading family, quality grade of each package.

### Segmentation of Personalized Packages

A segmentation model may be built to group various bundles based on the “similarity” of their attributes. It is difficult to simultaneously consider all the attributes in a clustering model. However, since some attributes are known to be more important than the others, a hierarchical segmentation model is proposed, in which all the attributes are put in priority order to capture the various aspects of each bundle.

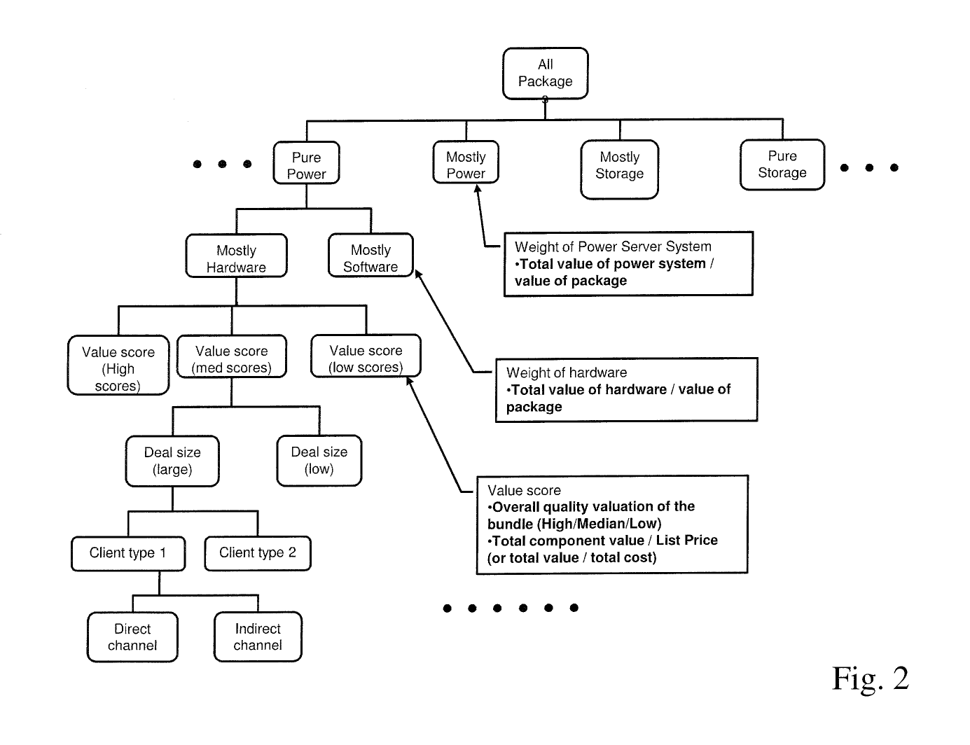

FIG. 2 illustrates an example of a hierarchical segmentation of personalized packages. In this example, the leading system may be the first attribute to consider, because it shows the dominant system in the entire bundle. Consider, as an example, a bundle containing two “big families”; one is the power server system, and the other is the storage system. The family of HE Power, Median Power and LE Power, for example, all belongs to the Power Server System. The system may be regarded as a higher level classification of the families. For example, server-base systems may provide on average higher profit than storage-base systems. Second, the composition of hardware and software may be considered. The seller prices hardware based on a reasonable profit margin over the manufacturing cost, however the seller prices software by a discount from the list price. Third, the quality grade of bundle may be considered. For example, the systematic performance is normal if the buyer only selects a basic model. However, the performance is more powerful if the buyer has an enhanced model. Given a hardware-base bundle, the grade is measured by

$$\frac{{\sum }_{j ∈ B} {v}_{j} - {c}_{B}}{{c}_{B}} .$$

With respect to a software-base bundle, the overall grade is measured by

$$\frac{{\overline{p}}_{B} - {\sum }_{j ∈ B} {v}_{j}}{{\overline{p}}_{B}} .$$

Deal size may be the fourth attribute of concern in this example. Normally, a buyer looks for a discount based on quantity, if the bundle is of large size. The four factors addressed above are relevant to the feature of bundles. Moreover, the segmentation model may also consider the client type, such as customer incumbency (acquisition or retention). FIG. 2 summarizes the hierarchical model, where the five example attributes are considered one by one. In each level, the segmentation is supported by many robust clustering methods.

### Normalized and Recursive Utility Model

After putting the similar bundles together, the buyers' utility in each segment is analyzed. Here, the methodology of the present disclosure may look for a utility function including all the attributes addressed above under Characteristic of Package and Segmentation of Personalized Package headings. The utility function may be formulated as in Equation (1), for a customer i buying a bundle B.

The utility function may be normalized by the aggregated component value

$${v}_{B} = {\sum }_{j ∈ B} {v}_{j} ,$$

that is u_{B}ⁱ=U_{B}ⁱ/v_{B}. There is,

$${u}_{B}^{i} = {α}_{c} - {α}_{c} \frac{{v}_{B} - {c}_{B}}{{v}_{B}} + {α}_{l} + {α}_{l} \frac{{\overline{p}}_{B} - {v}_{B}}{{v}_{B}} - β \frac{{p}_{B}}{{v}_{B}} + {γ}_{H} + ( {γ}_{S} - {γ}_{H} ) \frac{{v}_{S}}{{v}_{B}} + {ɛ}_{B}^{i} . \qquad ( 4 )$$

Here, each regression variable has its explicit meanings. First,

$$\frac{{v}_{B} - {c}_{B}}{{v}_{B}}$$

rates the quality grade of a hardware-base bundle. It is relatively high-end, if it is able provide a higher “additional value” over the manufacturing cost. Therefore, α_{c} expected to be negative. Second,

$$\frac{{\overline{p}}_{B} - {v}_{B}}{{v}_{B}}$$

shows the quality of a software-base bundle. It is of high grade, if v_{B} is close to the list price, which leads to a smaller “value discount” from the list price. Hence, αₗ is expected to be negative. Without loss of generality, the methodology may set γ_{H}=1. It is super-additive between hardware and software, if γ_{H}−γ_{S}>0. Otherwise, it is sub-additive. The dependency between software and hardware may be significant in general. It allows to recalculate the value of bundles taking into account the correlation of software and hardware, which is formulated below:

\tilde{v}_{B}=v_{B}+(γ_{S}−γ_{H})v_{S}.

To explore the dependency between different product families, a utility model may be recursively derived based on the adjusted value calculated in the previous stage.

Next, the methodology of the present disclosure may further include the dependency among product families into the model. Consider K possible product families, indexed by k=1, . . . K. The methodology may calculate \tilde{v}ₖ=vₖ+(γ_{S}−γ_{H})v_{kS}. Without loss of generality, let “1” be the leading family. There is

$${\sum }_{k = 1}^{K} {γ}_{k} \frac{{\tilde{v}}_{k}}{{\tilde{v}}_{B}} = {γ}_{1} + ( {γ}_{2} - {γ}_{1} ) \frac{{\tilde{v}}_{2}}{{\tilde{v}}_{B}} + … + ( {γ}_{K} - {γ}_{1} ) \frac{{\tilde{v}}_{k}}{{\tilde{v}}_{B}} .$$

It leads to a revised utility function that focuses on the correlation between the leading family and the others. The methodology of the present disclosure may replace

$${γ}_{H} \frac{{v}_{H}}{{v}_{B}} + {γ}_{S} \frac{{v}_{S}}{{v}_{B}} by {\sum }_{k = 1}^{K} {γ}_{k} \frac{{\tilde{v}}_{k}}{{\tilde{v}}_{B}}$$

in (4), and modify the utility model as follows:

$${\tilde{u}}_{B}^{i} = {\tilde{α}}_{c} - {\tilde{α}}_{c} \frac{{\tilde{v}}_{B} - {c}_{B}}{{\tilde{v}}_{B}} + {\tilde{α}}_{l} + {\tilde{α}}_{l} \frac{{\overline{p}}_{B} - {\tilde{v}}_{B}}{{\tilde{v}}_{B}} - \tilde{β} \frac{{p}_{B}}{{\tilde{v}}_{B}} + {γ}_{1} + ( {γ}_{2} - {γ}_{1} ) \frac{{\tilde{v}}_{2}}{{\tilde{v}}_{B}} + … + ( {γ}_{K} - {γ}_{1} ) \frac{{\tilde{v}}_{K}}{{\tilde{v}}_{B}} + {ɛ}_{B}^{i} . \qquad ( 5 )$$

The sign of γₖ−γ₁ shows the additive effect of correlation between the leading family and the others. Thus, the bundle value may be revised as in

$${\hat{v}}_{B} = {\tilde{v}}_{B} + {\sum }_{k = 2}^{K} ( {γ}_{k} - {γ}_{1} ) {\tilde{v}}_{k} .$$

Note, \hat{v}_{B} has already taken into account the correlation among the commodities and families, which leads to a more “precise” estimation of price elasticity.

The methodology may further modify the utility function to refine the estimation of price elasticity. It is measured by \hat{B} which is a factor of concern in the price optimization.

$${\hat{u}}_{B}^{i} = \hat{α} - {\hat{α}}_{c} \frac{{\hat{v}}_{B} - {c}_{B}}{{\hat{v}}_{B}} + {\hat{α}}_{l} \frac{{\overline{p}}_{B} - {\hat{v}}_{B}}{{\hat{v}}_{B}} - + \hat{β} \frac{{p}_{B}}{{\hat{v}}_{B}} + {ɛ}_{B}^{i} . \qquad ( 6 )$$

Note, the estimation on the commodity correlation for the leading family may be adjusted, if

$$( {γ}_{1 S} - {γ}_{1 H} ) \frac{{v}_{1 S}}{{v}_{1}}$$

is added on the utility function (6). Moreover, if necessary,

$$( {\hat{γ}}_{S} - {\hat{γ}}_{H} ) \frac{{\hat{v}}_{S}}{{\hat{v}}_{B}}$$

may be added on (6), in order to re-estimate the commodity correlation for all the product families. If so, the methodology may refer back to the utility model as in (4) in a recursive manner.

The following summarizes the entire utility model in Proposition 1, where the normalization and recursiveness play a role.

Proposition 1: The additive effect inside the bundle is calculated in a recursive manner, where it is assumed the leading family is indexed by 1.

Normalize the utility function by v_{B}, estimate the commodity dependency by γ_{S}−γ_{H} as in (4), and calculate an adjusted value \tilde{v}_{B}=v_{B}+(γ_{S}−γ_{H})v_{S}, and \tilde{v}ₖ=vₖ+(γ_{kS}−γ_{kH})v_{kS}, for k=1, . . . , K.

Normalize the utility function by \tilde{v}_{B}, estimate the family correlation by γₖ−γ₁ as in (5), for k=2, . . . , K, and calculate an adjusted value \hat{v}_{B}=\tilde{v}_{B}+Σₖ₌₂^{K}(γₖ−γ₁)\tilde{v}ₖ.

Normalize the utility function by \hat{v}_{B}, estimate the price elasticity for the entire bundle as in (6).

Note, all the regression coefficients are estimated for each segment i=1, . . . , I. Therefore, it may be assumed they are homogeneous in the same segment, but heterogeneous across different segments.

The utility model may be used to build a discrete choice model to measure the purchase probability of the entire bundle, B, given the seller's approved price p_{B}. Let q(p_{B}) be the seller's win probability, which is the likelihood of purchasing the bundle at the price of p_{B}. Here some choice model is applied based the different assumptions of the random variable ε_{B}ⁱ. A binomial logistics model (BML) follows the doubly exponential distribution, and provides a closed-form of the choice probability. Let ū_{B} be the deterministic utility of (6), excluding the random variable. There is

$$q ( {p}_{B} ) = \frac{exp ( {\overline{u}}_{B} )}{exp ( 0 ) + exp ( {\overline{u}}_{B} )} , \qquad ( 7 )$$

where the utility of non-purchase is assumed to be zero.

If it is assumed the random variable satisfies the normal distribution, a probit model is applied to the utility function. The following description demonstrates how to optimize the bundle price based on a logistics model.

In Equation (7), ū_{B} is Equation (6)'s deterministic part where the random variable epsilon is removed. In Equation (7), the relationship between the purchase probability q and the price p_{B}, which is included in the ū_{B}, is known. All the parameters are known except for p_{B}. Therefore, for each price point p_{B}, the corresponding purchase probability q may be obtained.

### Pricing Optimization and Managerial Insights

A seller may use a choice model to maximize the expected profit. A pricing optimization may be formulated as the choice model. In addition, a method may be provided to validate the model and verify the business impact.

### Pricing Optimization

For explicit formulation, the methodology of the present disclosure may use the logistic model to illustrate the pricing optimization. To ease the notation, the subscript “B” is dropped in this description, since all the variables and coefficients are defined in the bundle level in the pricing optimization. Let G be the expected profit and R be the expected revenue. There is

$${max}_{p} G ( p ) = ( p - c ) q ( p ) \qquad ( 8 )$$

$$\begin{matrix}s . t . R ( p ) = p \cdot q ( p ) \geq \underline{R} , for any \underline{R} \leq {max}_{p} R ( p ) ; & ( 9 ) \\ \overline{p} \geq p \geq \underline{p} . & ( 10 )\end{matrix}$$

The pricing decision may include other constraints. For example, a seller often expects the expected revenue to reach a target level R (see (9)). Note such revenue target cannot be higher than the maximum expected revenue. If the seller aims to expand the market share by δ percent, the seller may set the revenue target at R=(1+δ)p°q(p°). Here p° is the unconstrained profit maximizer, that is

$$p° = arg {max}_{p} G ( p ) .$$

Moreover, there might be some bounds on the pricing decision as in (10). Typically, there may be the list price as the upper-bound and the cost as the lower-bound. To solve the constrained optimization problem, a variable transformation may be performed, using the purchase probability q as the decision variable instead of the price p. Because q(p) is a decreasing function, it commits a monotone inverse function p(q). It may be used to revise the constrained maximization problem.

$${max}_{q} G ( q ) = ( p ( q ) - c ) q \\ s . t . R ( q ) = p ( q ) \cdot q \geq \underline{R} , for any \underline{R} \leq {max}_{q} R ( q ) ; \\ \overline{p} \geq p ( q ) \geq \underline{p} . \qquad ( 11 )$$

Let

$$q ° = arg {max}_{q} G ( q )$$

be the unconstrained profit maximizer, and

$$\overline{q} ° = arg {max}_{q} R ( q )$$

be the unconstrained revenue maximizer. Note, there exists q°≦ q̅°, and R(q) is increasing in 0≦q≦ q̅°, which leads to an inverse function Q(R).

Proposition 2: Consider the following properties for the revised optimization problem as in (11).

• G(q) is strictly concave in q. It admits a unique optimum solution

$$q° = arg {max}_{q} G ( q ) ;$$

• In the presence of the revenue constraint, the optimal solution q*=max(q°,Q(R));

• In the presence of the price bounds, the optimal solution q*=min(q(p), max(q°,q( p̅)).

Proposition 2 shows that the logistic model has some attractive properties to support the industrial implementation. A similar optimization is applied to the probit model, although the closed-form solution does not exit.

### Model Validation and Business Impact

To apply the entire model in practice, a new approach is generated to validate the model and verify the business impact. To this end, the optimal price may be compared to the actual (approved) price. In one embodiment, the comparison may be made in four scenarios by using the conditional purchase probability. If the buyer bought the bundle, it is considered a “win” to the seller. Otherwise, it is considered as a “loss”.

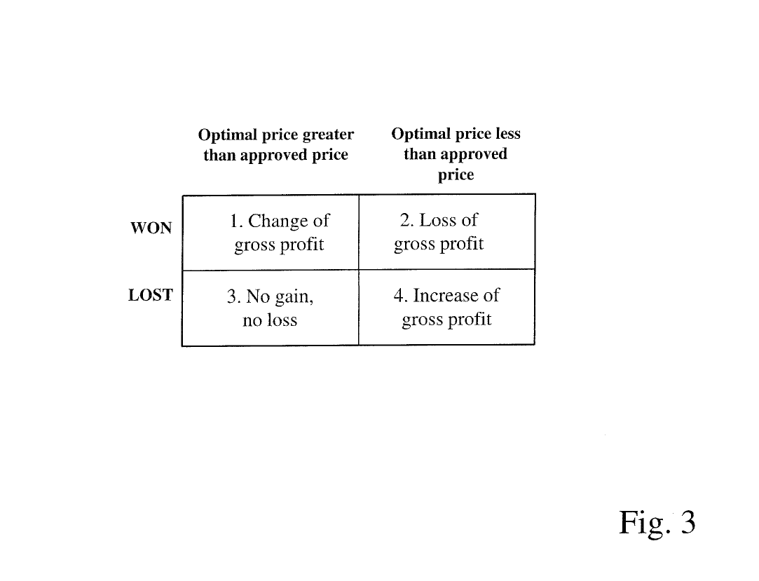

FIG. 3 shows model validation based on business impact in one embodiment of the present disclosure. In scenario 1, the optimal price is higher than the approved price (p*≧p) which led to a win. Then the optimal price would yield a win with the probability of

$$\frac{q ( {p}^{*} )}{q ( p )} .$$

It is a conditional probability that measures the chance to win at the optimal price given the approved price yielded a win. In summary, a net increment of profit is expected by

$$Δ {G}_{1} = ( {p}^{* } - c ) \frac{q ( {p}^{*} )}{q ( p )} - ( p - c ) .$$

In scenario 2, the optimal price is less than the approved price (p*<p) which led to a win. Then the optimal price is certainly accepted by the buyer. However, such optimal price would lead to a net gain by ΔG₂=p*−p<0. The negative sign means it is certainly a loss of profit.

In scenario 3, the optimal price is higher than the approved price (p*≧p) which yielded to a loss. The higher optimal price would certainly result in a loss. The net gain is zero, ΔG₃=0.

In scenario 4, the optimal price is less than the approved price (p*<p) which yielded to a loss in the past. However, the lower optimal price might bring some chance to convert the loss to win. Such chance is measured by a conditional probability

$$1 - \frac{1 - q ( {p}^{*} )}{1 - q ( p )} .$$

Hence, a net gain is expected by

$$Δ {G}_{4} = ( 1 - \frac{1 - q ( {p}^{*} )}{1 - q ( p )} ) ( {p}^{*} - c ) .$$

FIG. 3 summarizes the four scenarios addressed above. A net improvement on the profit may be expressed by

$$Δ G = \{ {( {p}^{*} - c ) [ \frac{q ( {p}^{*} )}{q ( p )} - 1 ]}^{-} + ( {p}^{*} - p ) \} {1}_{w} + \{ {[ 1 - \frac{1 - q ( {p}^{*} )}{1 - q ( p )} ]}^{+} ( {p}^{*} - c ) \} ( 1 - {1}_{w} ) . \qquad ( 12 )$$

Here, the notation is abbreviated as below: [x−y]⁺=max(x−y,0) and [x−y]⁻=−min(x−y,0). Moreover, 1_{w}, is the indicator function which equals to 1, if the approved price yielded a “win”. The goodness of fit may be used to validate the regression model, and the profit increment to verify the business impact.

Thus, for example, given the actual bids, actual quoted price and an optimal price computed by a methodology of the present disclosure in one embodiment, there may be four different scenarios shown in FIG. 3. Conditional win probabilities may be used to determine the probability of winning at a higher price if the actual approved price resulted in a “win” and the probability of winning at a lower price if the actual approved price resulted in a “loss.” The sum of the values of the four regions give the overall gain/loss of a model of the present disclosure that computes pricing for personalized packages.

### Real-Time Pricing Decision Based on Offline Analysis

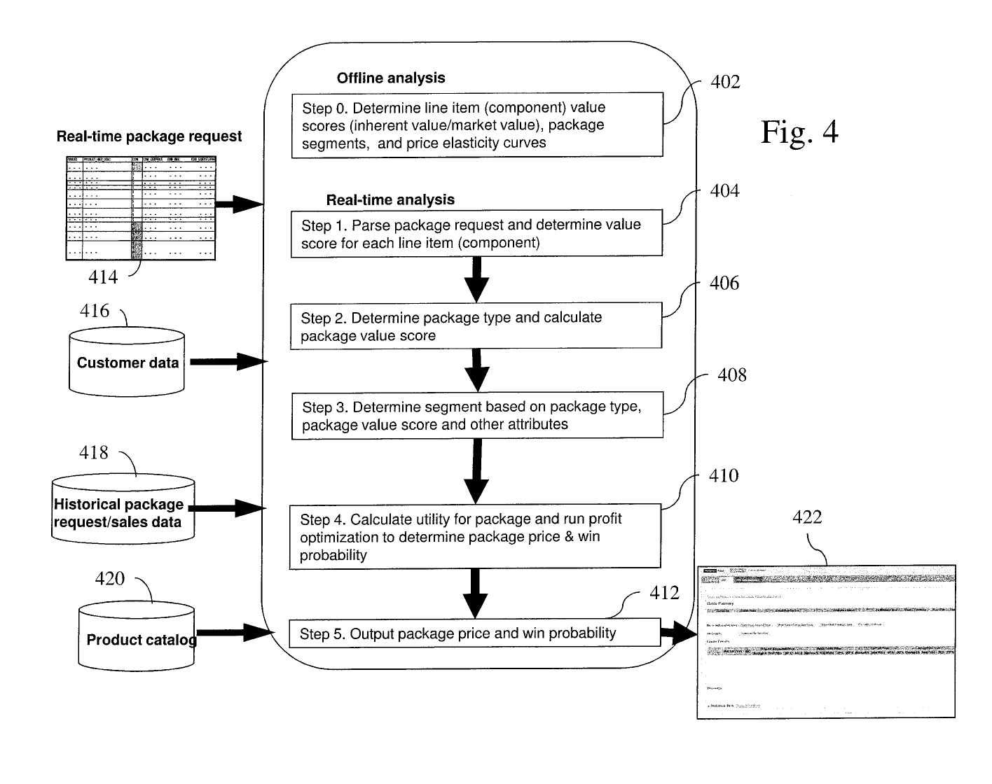

FIG. 4 illustrates a method for pricing personalized product bundles with unique configurations in one embodiment of the present disclosure, for instance, where there is limited price history (little or no sales history), for instance, due to the large number of combinations of bundles. At 402, an offline analysis may comprise determining component inherent values (value score for a component), package segments (e.g., as in FIG. 2), and price elasticity curves (utility function, e.g., as in Equation (7)) using available historical data associated with bundles priced and/or sold in the past. Historical bundles are decomposed into component parts, the value scores for the component parts determined, and a relationship between a component inherent value and its features is set up, e.g., as in Equations (2) and (3) as described above with reference to the top-down model. As described above with reference to the bottom-up model, those historical bundles are characterized according to their component inherent values and classified into package segments. A utility function associated with each of the package segments is generated based on the component inherent values of the bundles that are classified into the respective package segment. Coefficients to the utility functions may be obtained by the logistics regression in the bottom-up model.

At 404, a request is received, e.g., in real-time, to price a personalized package or bundle. A list of commodities (also referred to as line items or components) of a personalized package may be provided as input. As described above, packages may be configures by a customer, with millions of possible component combinations. The cost and value of some of the components in the package (e.g., service and software) may not be explicitly defined, depending on the combination of package. The package may contain a mixture of multiple commodities, e.g., hardware, software and service. There is no history for most packages. A personalized package or bundle may contain a configuration of various components of power-server/storage and hardware/software. Hardware may be associated with software or service. A methodology of the present disclosure may analyze a win/loss probabilities (whether a buyer would purchase at a price) at the package level, even in cases where there is no evidence of win/loss at the line-item (component) level, and no sales history for the same type of configurations. In one aspect, a graphical user interface may be provided for allowing a user to interact (e.g., input package data and receive output of the results) with a computerized functionalities or modules that compute the pricing according to the methodologies described herein. The results of the computation may be provided in any desired form, e.g., graphical user interface report or dashboard format, printed reports, etc.

The received package or bundle is parsed or decomposed into its components of various commodity types, and the inherent value (also referred to as value score) for each of the components may be determined based on the characteristics or features of each component. For instance, the relationship between a component inherent value and its features determined at 402, e.g., Equation (2) or Equation (3) whose coefficients have been determined using historical data, may be used to determine the inherent values for the components of the received package or bundle.

Referring to FIG. 4, at 406, package type (segment) of the received personalized package is determined, for example, based on or as a function of the components (or commodities) of the personalized package, and the value score of those components. For instance, as described above, the bundle is characterized by its attributes characterized by its component values. A value score for the personalized package is computed based on or as a function of (e.g., aggregate sum of) the value scores of its components, for example, as described above with reference to the bottom-up methodology. Customer data 416, along with other data, may be also used to determine the value score.

At 408, a segment, into which this bundle can be grouped or classified, is determined based on the package type and package value score computed at 406. That is, a corresponding segment for this bundle is identified and selected from the package segments whose utility functions have been built in the bottom-up model described above. Other attributes may be used to determine the segment.

At 410, a utility function associated with the determined package segment at 408 is calculated for the received personalized package or bundle, and profit optimization is run to determine a package price and win probability, for example, as described above under the Normalized and Recursive Utility Model and Pricing Optimization headings. The utility function as described above may be computed by aggregating the component values (line item value scores) of the components in the package determined at 406. The parameters of the utility function may be recursively adjusted.

The value of the bundled package may be normalized and related to historical bundled packages 418 to compute price sensitivity and offer acceptance probability which is used to price the bundle. In one embodiment of the present disclosure, the price of the bundle maximizes expected profit or revenue.

As an example, a personalized package (e.g., received at 404) may be characterized by:
A customer in a segment i, bids for a package having a set of components, indexed by j in the set of B, e.g., with a set of hardware H, and software S;
Customer i is characterized by its attributes Aᵢ.

The utility of a package (e.g., computed at 410) may be characterized by:
Package price (p_{B}), list price (p_{L}), total manufacturing cost (c_{B});
Package type (T as a function of B, H, S and vⱼ's);
Package value score (V as a function of vⱼ's).

The package type (T as a function of B, H, S and vⱼ's) and the package value score (V as a function of vⱼ's), e.g., is computed at 406. Known values, e.g., the package price, list price and total manufacturing cost may be obtained from a database of historical data.

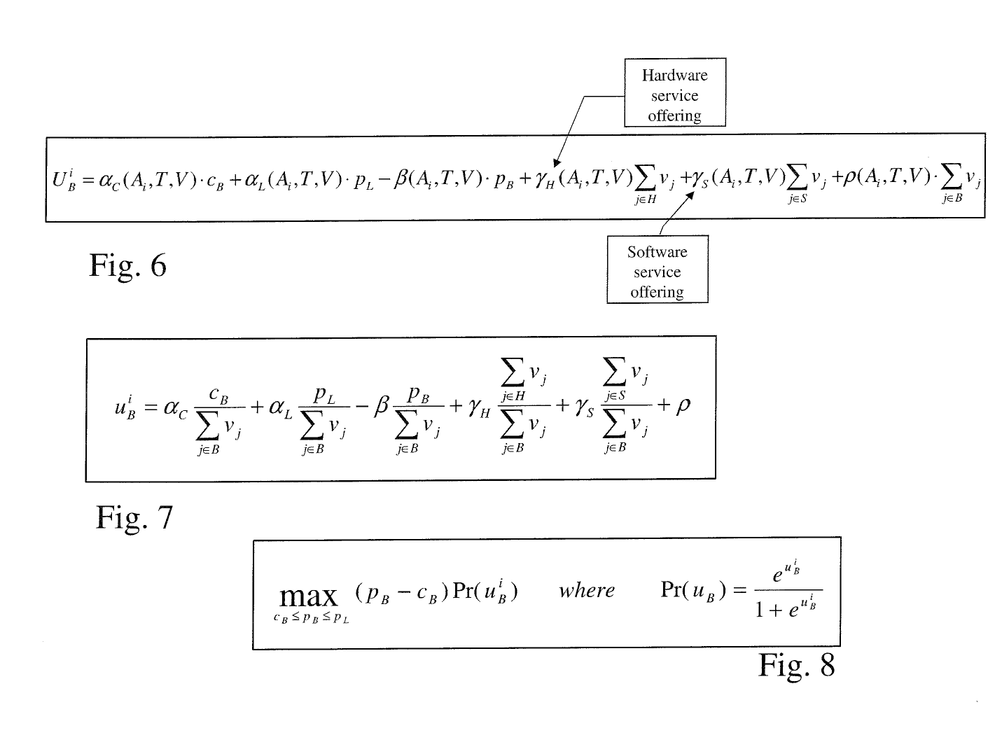

An example of a bundle utility function defined for personalized packages is shown in FIG. 6 (also expressed in Equation (1) above). A term in the function may represent hardware service offering of a package. Another term may represent software service offering component of a package. Using the utility function, p_{B} may be solved for any new bundle.

To analyze various packages, the utility function may be normalized by the package value, for example, as shown in FIG. 7 (also expressed in Equations (4)-(6) above).

Win probability estimation and price optimization may be computed according to the formula shown in FIG. 8 (also expressed in Equation (7) above). The “e” notation in FIG. 8 refers to an exponential value; “Pr” notation refers to probability.

At 412, the package price and win probability may be output 422. The output includes the optimal price and purchase probability. A product catalog 420 may be utilized to generate an appropriate listing.

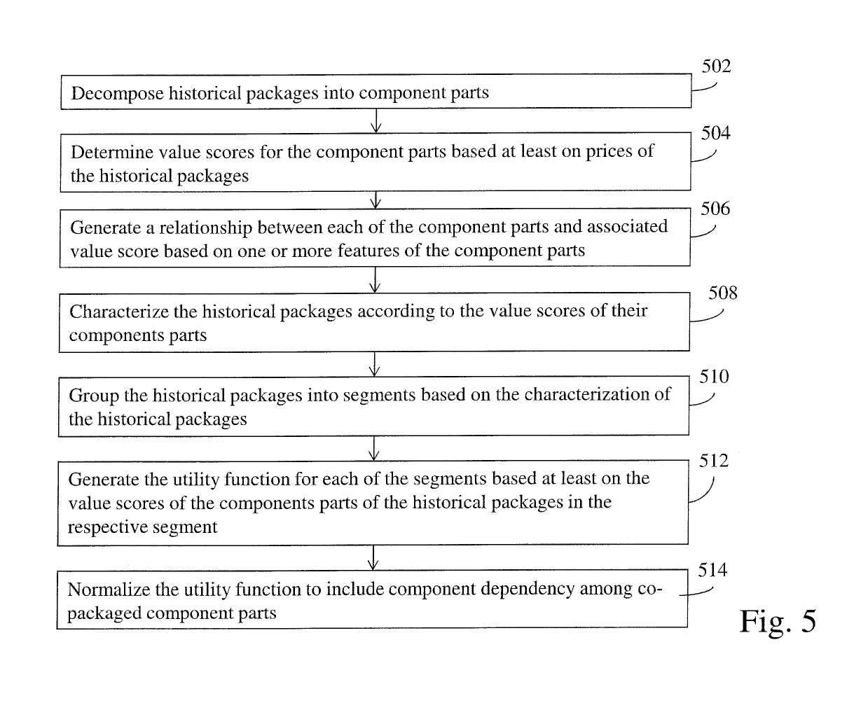

FIG. 5 illustrates a method of using historical data to generate utility functions associated with package bundle segments in one embodiment of the present disclosure. At 502, historical packages are decomposed into component parts. At 504, value scores for the component parts are computed based at least on prices of the historical packages. At 506, a relationship between each of the component parts and associated value score is generated based on one or more features of the component parts. The processing at 502, 504 and 506 are performed for example as described above with reference to a top-down model.

At 508, the historical packages are characterized according to the respective value scores of the components parts. At 510, the historical packages are grouped into segments based on the characterization of the historical packages. At 512, the utility function is generated for each of the segments based at least on the value scores of the components parts of the historical packages grouped in said each segment. At 514, the utility function is normalized to include component dependency among co-packaged component parts. The processing at 508, 510, 512 and 514 may be performed, for example, as described above with reference to a bottom-up model.

The component valuation may comprise decomposition or decomposing of a package into its components or commodities. Value scores are generated or computed for different commodities, for example, based on market position, cost, and other considerations. Generating the value scores for the individual commodities of the package may include classifying and determining a value of each commodity within a package. Component valuation may depend on the characteristic of the component such as Software/hardware/service; Product group and product family; Shelf-life information: new released, upgraded, and etc.; Market position (e.g., degree of competition); Cost, list price and delegation floors. The package's value score is generated or computed based on the inherent value of each component. For example, the package attributes may be measured through the weight of commodity, weight of family, overall value score, etc. Systematic configuration, commodity configuration and package overall value score may be used to measure the package attributes. Segmentation or grouping at package level is performed; Similar packages may be grouped into segments. One or more attributes considered for segmenting may include, but are not limited to, package composition, value score, customer data, revenue segment, and channel. A bundle segmentation model may be generated to detect the similarity of various packages and normalize them by the value scores. A win probability may be estimated at package level. A probability of winning package (likelihood that the package will be sold) may be computed statistically, for example, using a model to estimate win probability of each personalized package. Variables considered may include, but are not limited to, bundle price normalized by bundle value, bundle composition, customer data. Profit optimization may be computed. For instance, optimal price for a package may be computed by maximizing expected profit by balancing probability of winning package at a price with profitability. Data Warehouse, for example, may store and maintain input data and intermediate results of the processing. The segmentation may be adjusted based on the profit optimization. The component classification may be adjusted based on the win probability estimation.

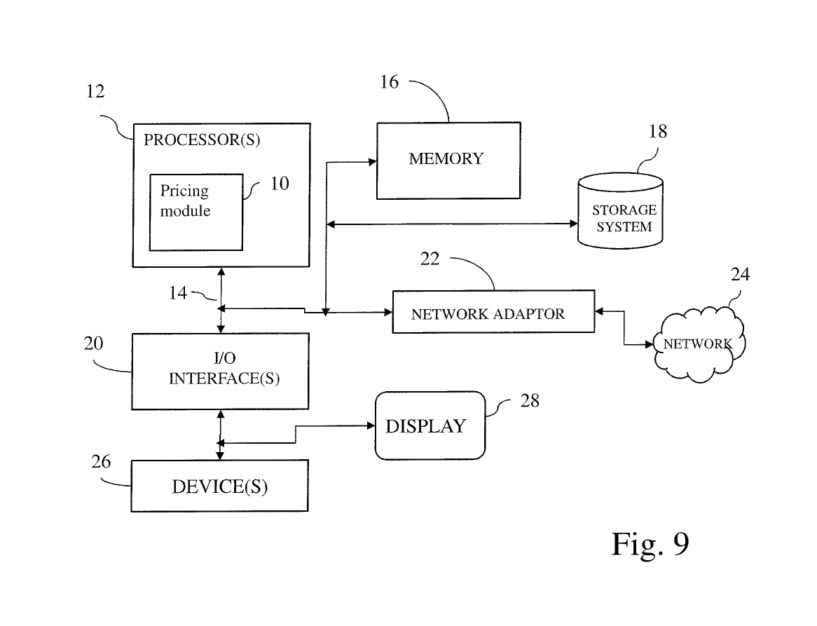

FIG. 9 illustrates a schematic of an example computer or processing system that may implement a pricing of a personalized package system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 91 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a pricing module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method of pricing a package with multiple commodities, comprising:
decomposing the package into the multiple commodities;
computing, by a processor, a value score for each of the multiple commodities based on at least one or more characteristics associated with said each of the multiple commodities;
computing, by the processor, a value score for the package based on at least the value score of each of the multiple commodities;
determining a package type of the package based on at least the value score of each of the multiple commodities;
identifying a segment for the package based at least on the package type and the value score of the package, from a plurality of segments each associated with a utility function; and
computing the utility function associated with the identified segment to determine a package price.

2. The method of claim 1, wherein the utility function is generated based on historical data associated with historical packages, wherein generating the utility function comprises:
decomposing each of the historical packages into component parts;
determining value scores for the component parts based at least on prices of the historical packages;
generating a relationship between each of the component parts and associated value score based on one or more features of the component parts;
characterizing the historical packages according to the respective value scores of the components parts;
grouping the historical packages into segments based on the characterization of the historical packages;
generating the utility function for each of the segments based at least on the value scores of the components parts of the historical packages grouped in said each segment; and
normalizing the utility function to include component dependency among co-packaged component parts.

3. The method of claim 2, wherein the utility function includes a regression and the coefficients to the regression are determined using historical data associated with the historical packages in the respective segment.

4. The method of claim 2, wherein the historical packages are characterized by one or more of a weight given to a commodity type in a historical package, a weight given to a product family in the historical package, a leading group of components having similar functionality that provides a highest value in the historical package, or the overall grade of the historical package, or combinations thereof.

5. The method of claim 1, wherein the one or more characteristics associated with said each of the multiple commodities comprises commodity type, product family, shelf-life information, market position, or a cost parameter, or combinations thereof.

6. The method of claim 1, further comprising generating a win probability estimation function to determine an optimal price at which a buyer is likely to purchase the package.

7. The method of claim 1, wherein the computing of the value score for each of the multiple commodities, comprises calculating a predetermined regression relationship between a value of a commodity and one or more features associated with the commodity established using historical data.

8. The method of claim 1, wherein the package comprises computer system package having a set B of components, indexed by j in the set of B, with a set of hardware H, and software S, wherein the package is configured by a customer i, characterized by attributes I, wherein the utility function comprises
$${U}_{B}^{i} = {α}_{c} ( {A}_{i} , T , V ) \cdot {c}_{B} + {α}_{L} ( {A}_{i} , T , V ) \cdot {p}_{L} - β ( {A}_{i} , T , V ) \cdot {p}_{B} + {γ}_{H} ( {A}_{i} , T , V ) {\sum }_{j ∈ H} {v}_{j} + {γ}_{S} ( {A}_{i} , T , V ) {\sum }_{j ∈ S} {v}_{j} + ρ ( {A}_{i} , T , V ) \cdot {\sum }_{j ∈ B} {v}_{j} ,$$
characterized by a package price p_{B}, list price p_{L}, total manufacturing cost c_{B}, client demographic attribute Aᵢ, package type T as a function of B, H, S and vⱼ's, and package value score V as a function of vⱼ's.

9. The method of claim 1, wherein a likelihood of purchasing the package at price p_{B} is determined by
$$q ( {p}_{B} ) = \frac{exp ( {\overline{u}}_{B} )}{exp ( 0 ) + exp ( {\overline{u}}_{B} )} ,$$
wherein ū_{B} represents a deterministic utility of the utility function.

10.-20. (canceled)
